(19) United States
(12) Patent Application Publication
(10) Pub. No.: US 2019/0340945 A1
(43) Pub. Date: Nov. 7, 2019

(54) AUTOMATIC GENERATION AND PERSONALIZATION OF LEARNING PATHS

(71) Applicant: Microsoft Technology Licensing, LLC, Redmond, WA (US)

(72) Inventors: Eeshan Malhotra, Bangalore (IN); Nagaraj Kota, Bangalore (IN)

(21) Appl. No.: 15/970,754

(22) Filed: May 3, 2018

(51) Int. Cl. G09B 5/12; G06F 17/30; G06F 15/18

(52) U.S. Cl. CPC G09B 5/12; G06F 15/18; G06F 17/30867; G06F 17/30958

(57) ABSTRACT

Techniques for generating individualized learning paths are provided. A skill dependency graph is generated that indicates, for each pair of connecting nodes in the graph, a first skill in the pair as a prerequisite of a second skill in the pair. A set of destination skills is determined that a user is to obtain to achieve a possible career goal. Based on the skill dependency graph and the set of destination skills, one or more prerequisite skills that the user should obtain prior to obtaining the set of destination skills are identified. Based on the set of destination skills, the one or more prerequisite skills, and information about the user, an individualized learning path is generated that comprises a sequence of learning resources that allows the particular user to obtain a set of skills. The individualized learning path is presented on a screen of a computing device of the user.

### TECHNICAL FIELD

The present disclosure relates to online learning platforms and, more particularly, to leveraging skill dependencies and an individual's unique attributes to generate a learning path that is personalized to the individual.

### BACKGROUND

Modern society thrives with an educated workforce. The greater the skills and knowledge a person has, the greater the likelihood that that person will create things of value for herself and for those with whom she works. However, different people have different interests and career goals. Even individuals on the same career path or with the same job title may change course or specialize in different sub-areas. Modern tools to acquiring knowledge and skills has only accelerated knowledge and skill advancement. Such tools are available online and some are complimentary.

One approach for providing learning resources online is through a standalone video or course of multiple videos. However, individuals must discover such learning resources themselves through a search. Another approach for providing learning resources online is through a hand-curated, generic “specialization.” Both approaches suffer from similar problems: (1) each individual must figure out if the learning resource is too advanced or too elementary; (2) each individual must self-determine an order in which the learning resources must be consumed; (3) neither approach is personalized to the individual; (4) neither approach provides an indication of benefits to the user's career; (5) neither approach produces recommendations that evolve with an individual's personal growth.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for determining generating individualized learning paths, in an embodiment;

FIG. 2 is a block diagram that depicts an example recommendation of multiple individualized learning paths, in an embodiment;

FIG. 3 is a flow diagram that depicts a process for using a skill dependency graph to identify a set of skills that a user should acquire to reach a particular career goal, in an embodiment;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A method and system for generating a learning path for a user are provided. A learning path is a sequence of learning resources that a user can consume (e.g., watch, listen, or read) in order to obtain the necessary skills and knowledge to reach a goal. Information about the user is used to determine skills that the currently has and, based on a skill dependency graph that associates multiple pairs of skills, determine which learning resources should be consumed next. The skill dependency graph may be derived based on activities of other users.

A recommendation of a learning path for a user may be based on a fixed end goal (e.g., a desired job title) as input from the user or may comprise open-ended suggestions that lead to multiple possible goals. The user may be presented with a single learning path or multiple learning paths from which to choose.

### Example System

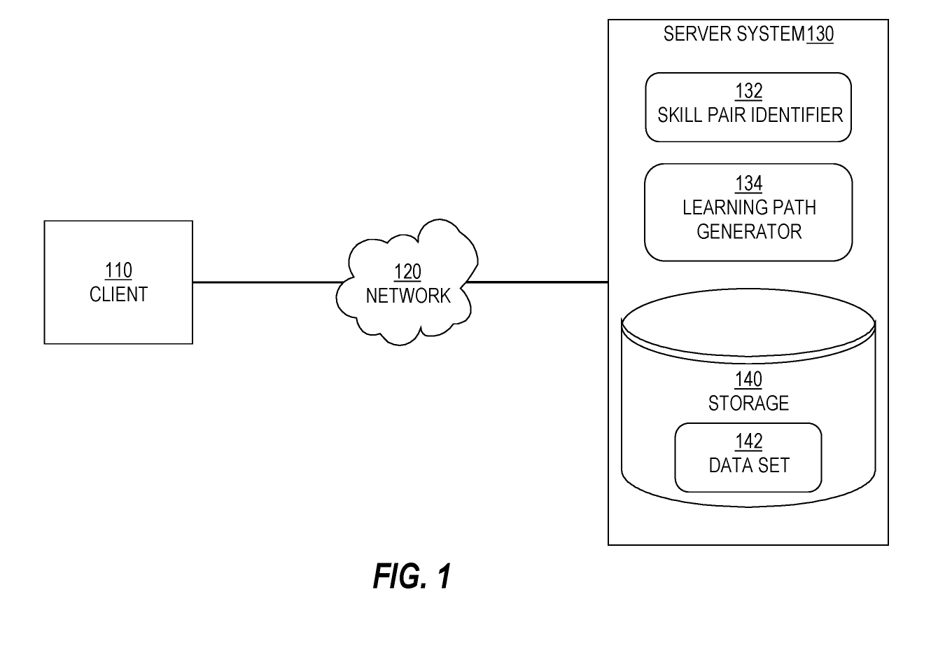

FIG. 1 is a block diagram that depicts an example system 100 for determining generating individualized learning paths, in an embodiment. System 100 includes a client device 110, a network 120, and a server system 130.

Client 110 is an application or computing device that is configured to communicate with server system 130 over network 120. Although only a single client 110 is depicted, system 100 may include multiple clients that interact with server system 130 over network 120. Examples of computing devices include a laptop computer, a tablet computer, a smartphone, a desktop computer, and a Personal Digital Assistant (PDA). An example of an application includes a dedicated application that is installed and executed on a local computing device and that is configured to communicate with server 130 over network 120. Another example of an application is a web application that is downloaded from server system 130 and that executes within a web browser executing on a computing device. Client 110 may be implemented in hardware, software, or a combination of hardware and software.

Network 120 may be implemented on any medium or mechanism that provides for the exchange of data between client 110 and server system 130. Examples of network 120 include, without limitation, a network such as a Local Area Network (LAN), Wide Area Network (WAN), Ethernet or the Internet, or one or more terrestrial, satellite or wireless links.

### Server System

As depicted in FIG. 1, server system 130 includes (1) a skill pair identifier 132 that identifies, based on data set 142 that is stored in storage 140, multiple skill pairs and (2) a learning path generator 134 that determines, based on data set 142 (or a separate data set), one or more sequences of learning resources for each user of multiple users.

In an embodiment, data set 142 comprises multiple entity (or user) profiles, each provided by a different entity (or user). In this embodiment, server system 130 maintains accounts for multiple users. Server system 130 may provide a web service, such as a social networking service. Examples of a social networking service include Facebook, LinkedIn, and Google+. Although depicted as a single element, server system 130 may comprise multiple computing elements and devices, connected in a local network or distributed regionally or globally across many networks, such as the Internet. Thus, server system 130 may comprise multiple computing elements other than skill pair identifier 132 and learning path generator 134.

### Profile

A user's profile may include a first name, last name, an email address, residence information, a mailing address, a phone number, one or more educational institutions attended, one or more current and/or previous employers, one or more current and/or previous job titles, a list of skills, a list of endorsements, and/or names or identities of friends, contacts, connections of the user, and derived data that is based on actions that the candidate has taken. Examples of such actions include jobs to which the user has applied, views of job postings, views of company pages, private messages between the user and other users in the user's social network, and public messages that the user posted and that are visible to users outside of the user's social network.

Some data within a user's profile (e.g., work history) may be provided by the user while other data within the user's profile (e.g., endorsement) may be provided by a third party, while other data within the user's profile (e.g., skills) may be provided by the user and a third party, such as a “friend” or connection of the user or a colleague of the user.

Before data set 142 is analyzed, server system 130 may prompt users to provide profile information in one of a number of ways. For example, server system 130 may have provided a web page with a text field for one or more of the above-referenced types of information. In response to receiving profile information from a user's device, server system 130 stores the information in an account that is associated with the user and that is associated with credential data that is used to authenticate the user to server system 130 when the user attempts to log into server system 130 at a later time. Each text string provided by a user may be stored in association with the field into which the text string was entered. For example, if a user enters “Sales Manager” in a job title field, then “Sales Manager” is stored in association with type data that indicates that “Sales Manager” is a job title. As another example, if a user enters “Java programming” in a skills field, then “Java programming” is stored in association with type data that indicates that “Java programming” is a skill.

In an embodiment, server system 130 stores access data in association with a user's account. Access data indicates which users, groups, or devices can access or view the user's profile or portions thereof. For example, first access data for a user's profile indicates that only the user's connections can view the user's personal interests, second access data indicates that confirmed recruiters can view the user's work history, and third access data indicates that anyone can view the user's endorsements and skills.

In an embodiment, some information in a user profile is determined automatically by server 130 (or another automatic process). For example, a user specifies, in his/her profile, a name of the user's employer. Server system 130 determines, based on the name, where the employer and/or user is located. If the employer has multiple offices, then a location of the user may be inferred based on an IP address associated with the user when the user registered with a social network service (e.g., provided by server system 130) and/or when the user last logged onto the social network service.

### Skills

In an embodiment, server system 130 stores skill data indicating and/or describing multiple skills. Each skill indicator is associated with a set of one or more words. A skill indicator may be a string of alphanumeric characters that comprises the set of one or more words or may map to the set of one or more words.

The multiple skill indicators may be organized into a skill taxonomy that lists all possible skills that are recognized by server system 130. The skill taxonomy may be manually created by one or more administrators of server system 130. The skill taxonomy may be updated from time to time based on (1) new technologies being developed that require new skills, (2) old skills becoming obsolete, (3) multiple skills merging into a single skill, and/or (4) a single skill being split into multiple distinct skills.

Skills listed in the skill taxonomy may be based on user-specified skills that users of server system 130 indicate in their respective profiles, in other users' profiles, in job listings, and/or in other descriptions of job positions. For example, some of such skill indicators may be included in the skill taxonomy and other skill indicators ignored. As another example, skills that are listed in job listings may be given higher weight than skills listed in an individual's profile. (The “weight” of a skill may refer to (a) how likely the corresponding skill indicator will be considered for inclusion in the skill taxonomy or (b) how little scrutiny that skill indicator will receive before being included in the skill taxonomy.) Similarly, skills that are listed in job listings posted by large, reputable organizations (e.g., companies) may be given higher weight than skills listed in job listings posted by small or unknown organizations. As another example, only skills that are listed in a threshold number of user profiles may be considered for inclusion in the skill taxonomy.

Skills listed in the skill taxonomy may be organized into skill groups and, additionally or alternatively, into a hierarchy. For example, “patent prosecution,” “patent litigation,” “prosecution,” and “patentability” may be assigned to a skill group entitled “Patent Law,” which itself may be in a skill super group (or skill domain) entitled “Legal.”

While some skills may be associated with a single term or phrase, some skills may be associated with multiple synonymous terms or phrases. For example, “C++” and “C++ programming” may be considered synonymous and may be defined as referring to the same skill. As another example, “machine learning” and “ML engineering” may be considered the same skill. Thus, even though a set of synonymous skills (that corresponds to a single skill) may be listed in a single profile, only a single occurrence of the corresponding skill may be counted.

### Associating Skills with a Learning Resource

An association between a skill and a learning resource may have been generated manually or automatically. For example, an author or creator of a learning resource may specify (e.g., tag) one or more skills for the learning resource. Such specifying may result in creating metadata for the learning resource.

As another example, one or more skills may be automatically determined by (e.g., skill identifier 132) analyzing one or more portions of the learning resource, such as a title, an abstract, summary, or synopsis, or content from the “body” (or main portion) of the learning resource. For example, text from any portion of the learning resource may be considered when identifying important words and phrases. As another example, audio from a learning resource (which may be or contain an audio file or a video file) may be translated into text, which is then analyzed for certain words and phrases. Whatever the source of the text from a learning resource (e.g., whether contained directly in the learning resource or generated using audio-to-text translation), a set of pre-defined skills (e.g., from a skills taxonomy) may be compared to the text to identify whether the text contains information about the set of pre-defined skills.

In an embodiment, a single learning resource is manually associated with a first skill and is automatically associated (e.g., by skill identifier 132) with a second skill.

In an embodiment, data outside of a learning resource is used to identify candidate skills and determine whether (or how much) to associate the one or more identified skills with the learning resource. Examples of such data include descriptions (e.g., by an author or by an official reviewer) of the learning resource that are found on the same or different platform on which the learning resource is provided, online reviews of the learning resource by consumers of the learning resource (again, whether found on the same or different platform), skills specified in profiles by users who previously consumed (e.g., viewed) the learning resource, crowdsourcing from users or independent labelers, and propagating skills (e.g., from a parent course (that is manually tagged) to an individual video or vice versa; from one learning resource to another if both are known to be “linked”). For example, if a user watches an entire video course and then updates his/her profile with skill A, then the video course is associated with skill A. There may be a time requirement that the update to the user's profile occur within a particular time period (e.g., one week) of consuming the learning resource.

In an embodiment, some text may be considered more relevant than other text in determining whether (or how much) a particular skill is associated with a corresponding learning resource. For example, if a title or metadata of a learning resource indicates a first skill, then it is more likely that the learning resource is dedicated to teaching that first skill than in teaching a second skill that is mentioned only in the body of the learning resource. As another example, if multiple online reviews of a learning resource indicate a first skill, then it is more likely that the learning resource is dedicated to teaching that first skill than in teaching a second skill that is not mentioned in any of the online reviews.

In an embodiment, frequency of skill indications in a learning resource (or about the learning resource) is a factor in determining whether (or how much) to associate a particular skill with the learning resource. For example, a first skill that is detected ten times in (or about) a learning resource is more likely to be associated with the learning resource (or have a higher score in association with the learning resource) than a second skill that is detected only two times in (or about) the learning resource. When determining a frequency of a skill indication associated with a learning resource, each occurrence of a synonym of the skill may be counted toward the frequency of the skill.

In an embodiment, skills are identified for associating with learning resources using one or more machine learning techniques. For example, training data may comprise learning resources and, for each learning resource, one or more skill indicators that have been manually-tagged. Then, a machine learning technique is used to discover which of multiple features are most determinative in identifying appropriate skills for other learning resources. Examples features may include token (e.g., words, n-grams or phrases, or subsets of words) frequency in the metadata of a learning resource, token frequency in the body or content of the learning resource, raw video or audio features, a difficulty level of a resource (tagged using a separate pipeline), and skills already tagged to ancestors/descendants in an ontology or known related resources.

### Skill Dependency Graph

A skill dependency graph is a set of skill pairs, each skill pair associating one skill with another skill. Each skill pair has an order, where the first skill is a prerequisite of the second skill. For example, the skill indicated in the first position of a skill pair may be considered the prerequisite of the skill indicated in the second position of the skill pair.

A particular skill may be indicated in the first position of multiple skill pairs, indicating that the particular skill is a prerequisite to multiple skills. Additionally, a certain skill may be indicated in the second position of multiple skill pairs, indicating that the certain skill requires multiple pre-requisite skills. In a related embodiment, a single skill pair associates multiple prerequisite skills with a single skill. In a related embodiment, a single skill pair associates a single prerequisite skill with multiple skills.

A skill graph may be generated using one or more techniques. In one technique, profiles (e.g., in a social network) of multiple users are analyzed to identify one or more possible skill pairs. For example, snapshots of a user profile may indicate a different set of skills over time. As a specific example, at time 1, a user profile lists skills A, B, and C. At time 2, the user profile lists skills A, B, C, and D. Based on this information, three skill pairs may be generated, one for skills A and D, one for skills B and D, and one for skills C and D. If a particular skill is listed in a profile at one point in time, but not at a later point in time when a new skill is added, then the particular skill might not be considered a prerequisite of the new skill.

In a related technique, prior to identifying a skill pair based on changes in a user's profile, the skills in the user's profile are mapped to skills in a skills taxonomy. For example, skill A may be mapped to skill A′ and skill B may be mapped to skill B′. Later, when skill D is identified in the user's profile, a (e.g., candidate) skill pair is generated for skill A′ and D (or skills B′ and D′ if skill D is mapped to skill D′) and a skill pair is generated for skills B′ and D (or skills B′ and D′ if skill D is mapped to skill D′).

In an embodiment, greater weight is given to skill pairs that occurred most recently. For example, if skills A and B were added to a user profile at time 1, skill C was added at time 2, and skill D was added at time 3, then greater weight is assigned to the skill pair C-D than to skill pairs for A-D and B-D. Thus, it is more likely that skill pair C-D will be reflected in a skill graph.

In an embodiment, the more instances of a first skill pair over a second skill pair indicates that there is a likelihood that the first skill pair represents an actual skill-prerequisite skill pairing. The second skill pair may be ignored if the number of instances is below a certain threshold or whose number of instances is less than a certain percentage threshold relative to a number of instances of a known or confirmed skill pair.

In another technique, an individual's usage of one or more learning resources is used in conjunction with skills listed in the individual's profile to identify one or more possible skill pairs. As described herein, a learning resource may be associated with one or more skills. If a user consumes a learning resource, then a skill pair (or at least a candidate or possible skill pair) may be generated for pairing of a skill in the user's profile and a skill associated with the learning resource. For example, if a user's profile lists three skills and a learning resource is associated with two skills (and there is no overlap in the respective skills), then six skill pairs may be generated.

In a related technique, prior to identifying a skill pair based on an individual's usage of a learning resource, the skills listed in the individual's profile and/or associated with the learning resource are first mapped to skills in a skills taxonomy and the mapped-to skills are used to generate skill pairs.

Generating skill pairs in either technique may result in a lot of unique skill pairs. In an embodiment, some skill pairs are ignored (or removed) so that they are not included in a skill dependency graph. Frequency may be a factor in removing some skill pairs. For example, if a skill pair occurs less than a threshold number of times, then the skill pair is ignored. As another example, a candidate skill pair must occur over a first threshold number of times under the first technique (i.e., analyzing changes in user profiles over time) and the candidate skill pair must occur over a second threshold number of times under the second technique (i.e., analyzing user consumption of learning resources). Additionally or alternatively, manual review of skill pairs may result in keeping some skill pairs and deleting others. Such a manual review may be limited to only skill pairs that occur less than a threshold number of times.

In an embodiment, existing learning courses that comprise a sequence of multiple learning resources are used to identify skill pairs. For example, a first learning resource in a course is associated with skills A and B (whether associated manually or automatically based on text analysis or machine learning) and a second learning resource in the course is associated with skill C (whether associated manually or automatically based on text analysis or machine learning), then it is inferred that skills A and B are prerequisites of skill C. Thus, two skill pairs may be generated: one for skill pair A-C and one for skill pair B-C.

In an embodiment, skill pairs for at least some portions of a skill dependency graph are determined using one or more machine learning techniques. The training data for training a machine-learned model comprises information about multiple possible pairs of skills. Known dependence relations may be used as training data. For example, sets of the form <skill A> depends on <skill B> or <skill X> does not depend on <skill Y>, i.e.

<A>,<B>,1

<X>,<Y>,0

Skill embeddings may be learnt and dependence probability predictions may be made pairwise, considering every pair of skills in both orders.

A variant involves representing the skill-pairs using features of interaction between skills, such as how many courses both skills feature together in, how often do the skills occur in successive courses in a learning path, and combining this with user-profile based features such as the ones below.

A different method may involve using time-tagged history of users to obtain samples of the form <skill A> is added to profile after <skill B>. From this data, the embeddings method described above may be used, or alternatively, this time-tagged history of users data is used with a simple evidence counting method, which would not be machine learning.

Output of the machine-learned model is a confidence score. Skill pairs whose score is above a confidence threshold are included in (or become part of) the skill dependency graph. Conversely, skill pairs whose score is below the confidence threshold are excluded from the skill dependency graph. In a related embodiment, if a confidence score of a skill pair is within a certain range (e.g., between 0.4 and 0.7), then such a skill pair may be marked for manual review and verification.

### Individual Career Goals

A user may have one or more career goals that involve the acquisition of one or more skills that the user does not already possess and may involve culminating in a particular job position or role. The user may specify a particular career goal or a career goal may be inferred based on data about the user. A career goal may be a particular set of one or more skills, a particular job title, a particular job listing, a particular job function, or a particular job position. Each job title, job listing, job function, and/or job position is associated with a set of skills. A set of such skills may be manually or automatically determined. For example, a job listing may list a set of skills that are required for the corresponding job, where a user creates the job listing and labels each skill indicator as a skill, allowing a processor to easily identify the skills. As another example, a description of a job position may include multiple skill indicators that are not labeled as skills, requiring a more sophisticated textual analysis of the description to extract the skill indicators.

In an embodiment, if a user does not provide input about a career goal by specifying a job title, job listing, or job position, then one or more career goals are inferred for the user based on data about the user. Example data about a user includes past experience (e.g., positions held, and companies worked for), previously consumed learning resources (e.g., watched videos, completed courses), previously submitted search queries (e.g., key search terms, user-selected search results), previously browsed learning pages, connections made with certain users (e.g., at certain organizations and/or with certain job titles/functions), previously sent/received messages to/from certain users (e.g., at certain organizations and/or with certain job titles/functions), and other inferred inclinations (e.g., past publications) or explicit inclinations (e.g., stated interests) derived from the user's profile. Thus, certain data in a user's profile and/or online activity of the user may be mapped to a pre-defined career goal.

For example, if textual analysis of keywords of a past searches of a user indicates a particular set of one or more skills that the user does not already possess (as indicated by the user's profile), then a career goal that is inferred may be limited to a career goal that (a) includes the particular set of one or more skills or (b) includes skills that require the particular set of one or more skills as prerequisites (or second or third order prerequisites).

As another example, if a user is making connections with, and sending messages with, users with a certain job title or job function, then that job title/function may be inferred as a possible career goal for the user.

In a related embodiment, in addition to leveraging data about a particular user, data about other users may be used to identify one or more possible career goals for the particular user. For example, a certain percentage of users (e.g., >35%) that listed a first job title in their respective user profiles at one point in the past later listed a second job title in their respective user profiles. Thus, if a user lists the first job title in his/her user profile, then a possible career goal for the user is the second job title.

As another example, a certain percentage of users (e.g., >25%) that searched for a particular topic and consumed multiple learning resources related to that topic later applied to jobs related to a particular job title. Thus, if a user has searched for the particular topic and consumed multiple learning resources related to that topic, then a possible career goal for the user is the particular job title.

As another example, a certain number of users (e.g., >1,000) that browsed learning pages pertaining to a particular topic and viewed profile pages of companies and users in a particular industry related to the particular topic. Thus, if a user browsed learning pages pertaining to the particular topic and viewed profile pages of companies and users in the particular industry, then possible career goals for the user may include the top N job titles listed in the viewed user profiles.

Thus, a particular user's current profile and/or online activity can be matched to other users' profiles/online activity at a certain time in the other users' past. If a set of other users match the particular user (e.g., according to a similarity scores associated with the other users in the set), then the current states of the set of other users' careers may be used to identify possible career goals for the particular user.

### Individualized Learning Path

In an embodiment, learning path generator 134 generates an individualized learning path for a user based on data about the user, a career goal associated with the user, and a skill dependency graph (that is generated, for example, based on online activities of multiple users). An individualized learning path (ILP) for a user may be generated in response to explicit input from the user. For example, a user is prompted to select a job listing or a future job title that the user desires to hold. In response to the user selecting a job listing or a job title, learning path identifier 134 generates an ILP for the user.

Alternatively, learning path generator 134 generates an ILP for a user without requiring explicit input from the user requesting one. However, the ILP may still be automatically displayed to the user, such as on a home page of the user that the user regularly visits. Alternatively, a link to the ILP may be displayed to the user, such as in an electronic message (e.g., email or text) addressed to the user or in an electronic feed associated with the user.

In an embodiment, learning path generator 134 generates an ILP in response to explicit user input requesting one, but where the input does not indicate any particular career goal. In such a scenario, learning path generator 134 generates one or more ILPs, one for each inferred career goal.

In a related embodiment, learning path generator 134 generates (1) a first ILP based on a first career goal that a user explicitly identifies and (2) one or more second ILPs based on each of one or more second career goals that the user did not explicitly identify. Such generation may be performed in response to user input that requests an ILP or that selects the first career goal.

### Example Recommendation

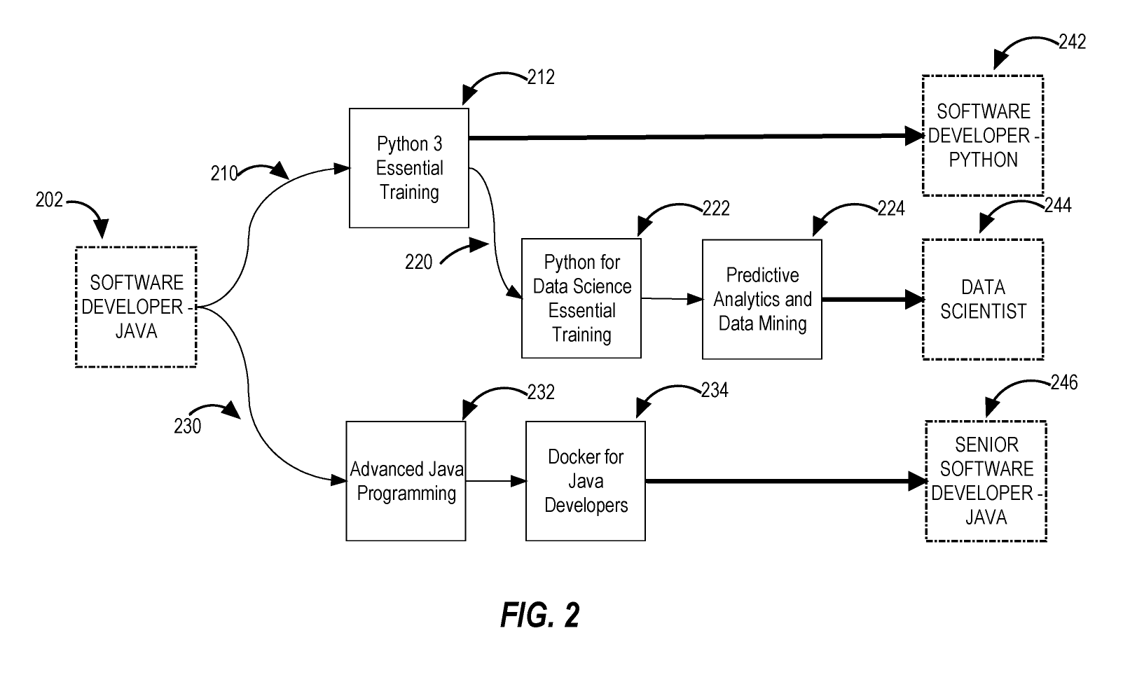

FIG. 2 is a block diagram that depicts an example recommendation of multiple individualized learning paths 210-230, in an embodiment. Each of ILPs 210-230 begin at a user's current state (i.e., current job title 202) and end at one of possible career goals 242-246. The user may have specified all, some, or none of career goals 242-246. Thus, one or more of career goals 242-246 may have been inferred by learning path generator 134.

In this example, ILP 210 comprises a single learning resource 212 that is intended to help the user acquire skills deemed necessary for career goal 242; ILP 220 comprises three learning resources 212, 222, and 224 that are intended to help the user acquire skills deemed necessary for career goal 244; and ILP 230 comprises two learning resources 232 and 234 that are intended to help the user acquire skills deemed necessary for career goal X46.

### Factors for ILP Generation

As noted above, learning path generator 134 generates an ILP based on data about the user, a career goal associated with the user, and a skill dependency graph. Multiple factors (or features, in machine learning parlance) may be considered in determining which learning resource should be taken next in order for a particular user to advance to his/her career goal, when explicit or inferred. Example factors include current job titles, past job title, current employer, past employer, consumed learning resources, submitted search queries, browsed learning pages, recently made connections made, content of sent/received messages to/from certain users (e.g., at certain organizations and/or with certain job titles/functions). For example, past searches may reveal skills that a user desires to acquire and, by inference (e.g., using the skill dependency graph), indicate which skills the user already has.

As described in more detail below, there are numerous ways to generate an ILP for a user. Embodiments are not limited to any particular way. There are two broad approaches for generating an ILP: a machine learning approach and a non-machine learning approach. Within each approach, there are multiple ways to implement each approach.

### Rule-Based ILP Generator

As noted above, learning path generator 134 may be implemented in one of a number of ways. For example, learning path generator 134 may be a rule-based generator or a machine-learned generator. For example, rules may be established that learning path generator 134 uses to identify one or more learning resources for a particular user. The rules are generic enough to produce unique ILPs for potentially many users.

Rules may be determined manually by analyzing characteristics of users who increased in skills and advanced in their respective careers or changed careers. For example, it may be determined that 45% of users who made a new connection to an employee of an organization, sent multiple messages to the new connection, and applied to multiple job positions associated with the organization ultimately advanced in his/her career.

A rule-based prediction model has numerous disadvantages. One disadvantage is that it fails to capture nonlinear correlations. Another issue with a rule-based prediction model is that the hand-selection of values is error-prone, time consuming, and non-probabilistic. Hand-selection also allows for bias from potentially mistaken business logic.

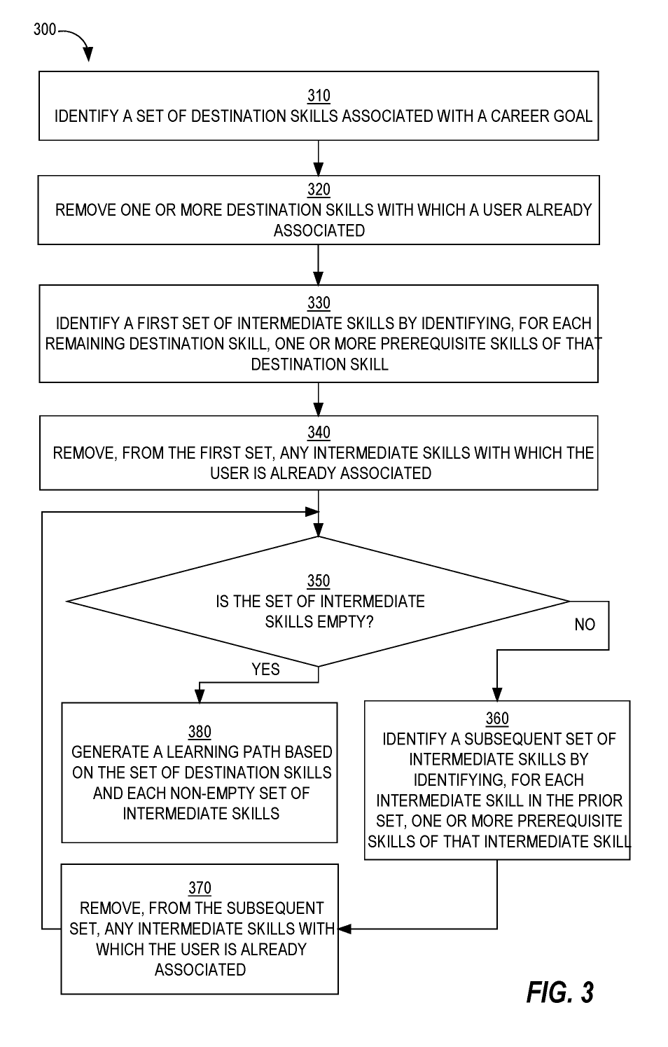

In an embodiment, a skill dependency graph is used to determine a set of skills (and a sequence of the skills) that a user should acquire in order reach a particular career goal. FIG. 3 is a flow diagram that depicts a process 300 for using a skill dependency graph to identify the set of skills, in an embodiment. Process 300 may be performed by learning path generator 134 and/or another component of server system 130. Process 300 may be performed individually for each user of multiple users.

At block 310, a set of one or more skills associated with the particular career goal is identified. This set is referred to as “career skills” or “destination skills”.

At block 320, one or more destination skills are removed if the user is already associated with those skills. The user may list those one or more destination skills in his/her profile or those skills may be inferred based on online activity of the user, such as the learning resources that the user has already consumed and/or the topics of searches that the user has previously initiated. For example, a user's profile may list skills that imply that s/he has a number of prerequisite skills that are not listed in the profile. As another example, a user's search history or previously consumed learning resources indicate that the user has acquired some skills that are not listed in the user's profile.

At block 330, for each skill in the set of destination skills, a set of one or more prerequisite skills is identified. For example, a destination skill is used to look up each skill-prerequisite skill pair whose second position matches the destination skill. The skill in the first position of each such skill-prerequisite skill pair is identified as a prerequisite skill or an “intermediate skill.” Thus, the set of one or more prerequisite skills may be referred to as a set of intermediate skills.

At block 340, one or more intermediate skills are removed from the set of intermediate skills if the user is already associated with those one or more intermediate skills.

At block 350, it is determined whether the set of intermediate skills remaining after block 340 is empty. If so, then the process 300 proceeds to block 380. Otherwise, process 300 proceeds to block 360.

At block 360, another (subsequent) set of intermediate skills that are prerequisites to the intermediate skills remaining after block 340 is identified.

At block 370, one or more intermediate skills are removed from the subsequent set of intermediate skills if the user is already associated with those one or more intermediate skills. Process 300 returns to block 350 to determine whether the subsequent set of intermediate skills remaining after block 360 is empty. If so, the process 300 proceeds to block 380. Otherwise, process 300 returns to block 360 where another set of intermediate skills that are prerequisites to the intermediate skills remaining after block 370 is identified.

At block 380, a learning path of one or more learning resources that teach the remaining intermediate skills and the remaining destination skills is generated. For example, skill A is a prerequisite to skills B and C and skill B is a prerequisite to skill D. A first learning resource that is associated with skill A is identified, a second learning resource that is associated with skills B and C is identified, and a third learning resource that is associated with skill D is identified. These three learning resources become a ILP for the user.

In a related example, the second learning resource is only associated with skill B, but not skill C. However, a fourth learning resource that is associated with skill C is identified and may be consumed either before or after the second learning resource. Thus, some learning resources in an ILP may be consumed in any order, while other learning resources should be consumed in a particular order, such as the first learning resource before the third learning resource.

### Selecting Learning Resources for an ILP

At each stage in a learning path, multiple learning resources that are associated with one or more skill needed by a user may be considered. In an embodiment, one or more resource selection criteria are used to select which of multiple candidates learning resources to include in an ILP for a user. The one or more resource selection criteria may include selecting the fewest learning resources, selecting the shortest set of learning resources (e.g., in terms of video time or number of words in the learning resources), selecting learning resources that are associated with the fewest skills that are not needed for an identified career goal for the user, selecting the highest ranked (or highest rated, e.g., by other users) learning resources, and selecting the most consumed (i.e., by others) learning resources.

For example, if a first learning resource is associated with more destination or prerequisite skills than a second learning resource, then the first learning resource is more likely to be selected. As another example, if a first learning resource is two hours in time length and a second learning resource is eight hours in time length, then the first learning resource is more likely to be selected. As another example, a first learning resource is associated four skills that are unnecessary for a user to achieve a particular career goal and a second learning resource is associated with only one skill that is unnecessary for the user, then the first learning resource is more likely to be selected. As another example, a first learning resource that has a user rating of 4 out of 5 stars and a second learning resource has a positive user rating of 3 out of 5 stars, then the first learning resource is more likely to be selected.

Some resource selection criteria may conflict with each other. Thus, some resource selection criteria may be given more weight or higher priority than other criteria. For example, the learning resource that is shortest length may be the most important criterion, followed by highest rated learning resource, and followed by most targeted (i.e., fewest superfluous or unnecessary skills taught) learning resource.

Some resource selection criteria may be ignored, for example, when two different learning resources or paths may be roughly equal under one criterion. For example, if two candidate learning paths are within one hour of each other in total length or viewing time, then other criteria may be controlling. As another example, if two candidate learning resources have the highest rating and are within twenty minutes of each other in length, then the learning resource that has been consumed the most is selected over the other learning resource.

In an embodiment, a learning resource that is selected for an ILP for a user is a portion (or subset) of a learning resource that is a course of separate materials. For example, a course comprises ten separate videos discussing different topics. A learning resource that is selected for an ILP may include videos three through seven, but excludes videos one, two, and eight to ten. Such a “dissection” of a course may occur if the excluded videos are not associated with (or do not lead to acquiring) a destination skill of the user or a prerequisite of a destination skill of the user.

### Machine-Learned ILP Generator

In an embodiment, one or more models are generated based on training data using one or more machine learning techniques. Machine learning is the study and construction of algorithms that can learn from, and make predictions on, data. Such algorithms operate by building a model from inputs in order to make data-driven predictions or decisions. Thus, a machine learning technique is used to generate a statistical model that is trained based on a history of attribute values associated with users and regions. The statistical model is trained based on multiple attributes (or factors) described herein. In machine learning parlance, such attributes are referred to as “features.” To generate and train a statistical prediction model, a set of features is specified and a set of training data is identified.

Embodiments are not limited to any particular machine learning technique for generating a prediction model. Example machine learning techniques include neural networks, linear regression, logistic regression, random forests, naive Bayes, and Support Vector Machines (SVMs). Advantages that machine-learned models have over rule-based models include the ability of machine-learned prediction models to output a probability (as opposed to a number that might not be translatable to a probability), the ability of machine-learned prediction models to capture non-linear correlations between features, and the reduction in bias in determining weights for different features.

A machine-learned prediction model may output different types of data or values, depending on the input features and the training data. For example, training data may comprise, for each user, multiple feature values, each corresponding to a different feature. Example features include the factors described previously. In order to generate the training data, information about each user is analyzed to compute the different feature values. In this example, the independent variables for each training instance may include a user's profile (such as the skills already possessed) and the skills that a learning resource provides. The dependent variable of each training instance may be whether the user eventually consumed the learning resource. Such a binary label can be changed to a fuzzy (i.e., non-binary value, such as between 0 and 1) if the learning resource was partially completed.

In an embodiment, the training data may include negative instances of career movement, each corresponding to a user that did not change careers after consuming a particular learning resource. The training data may be ensured to include at least a certain percentage of negative instances, such as 30% or 50% of all training instances in the training data.

Initially, the number of features that are considered for training may be significant. After training a prediction model and validating the prediction model, it may be determined that a subset of the features have little correlation or impact on the final output. In other words, such features have low predictive power. Thus, machine-learned weights for such features may be relatively small, such as 0.01 or −0.001. In contrast, weights of features that have significant predictive power may have an absolute value of 0.2 or higher. Features with little predictive power may be removed from the training data. Removing such features can speed up the process of training future prediction models and making predictions.

In an embodiment, supervised learning with a sequence modeling process is used to select learning resources for an ILP one learning resource at a time, using a classifier that predicts the appropriateness (e.g., represented by a probability) of a specific learning resource conditioned on the starting user profile, historical (generated) sequences of learning resources, and, potentially, also on a desired end-point (e.g., career goal).

One example of such a sequence modeling process is LSTM. Long short-term memory (LSTM) units (or blocks) are a building unit for layers of a recurrent neural network (RNN). A RNN composed of LSTM units may be referred to as an LSTM network. An LSTM unit may be composed of a cell, an input gate, an output gate, and a forget gate. The cell is responsible for “remembering” values over arbitrary time intervals. Each of the three gates can be thought of as a “conventional” artificial neuron, as in a multi-layer (or feedforward) neural network. Gates compute an activation (using an activation function) of a weighted sum. Intuitively, gates can be thought of as regulators of the flow of values that go through the connections of the LSTM.

A related approach to LSTM that may be leveraged to learn patterns of sequences of learning resources include Generative Adversarial Networks (GANs), which utilize the paradigm of (a) a “discriminator” learning to tell between true and simulated examples paired with (b) an adversary “generator” learning to produce synthetic examples that mimic real ones as closely as possible. The learned generator then generates an ILP for a user by utilizing the user's current profile (and other inputs as described above) as a starting point.

In an embodiment, whichever sequence modeling process is used, input to the model includes attributes of a user and the model, in turn, identifies (or outputs) a learning resource. While this is unconventional for a generative network, reinforcement learning techniques allow the model to learn using a policy improvement strategy. When identifying a candidate learning resource, the model attempts to mimic other learning paths that it has “seen” in the training data, which includes user attribute data of multiple users, learning resource data that indicates what each of those users consumed previously, and a job title or a set of skills that the respective user subsequently acquired. Each candidate learning resource that the model identifies may be associated with a probability or likelihood that the user should consume that candidate resource next. Thus, the model may produce, for a particular user, different sequences of learning resources that result in the same career goal (or different career goals) and that are associated with different probabilities or likelihoods.

In an embodiment, learning path generator 134 uses the skill dependency graph to determine whether a candidate learning resource satisfies conditions for being the next learning resource for a user to consume. For example, learning path generator 134 determines whether the candidate learning resource (a) teaches one or more skills required by the user to achieve the user's career goal and (b) does not require (as determined by the skill dependency graph) any skills that the user does not already have or that the user will not have after consuming a previously identified learning resource in an ILP for the user. Thus, if the candidate learning resource requires a skill that the user does not already have and that will not be obtained by a previously determined learning resource for the user, then the candidate learning resource is ignored, but it may be considered in a subsequent invocation of the machine learned model for this user. On the other hand, if the skill dependency graph includes a skill pair that indicates (1) a skill associated with the candidate learning resource and (2) a prerequisite skill that the user has (or that the user will acquire from consuming a previous learning resource that will be recommended to the user in an ILP), then learning path generator 134 inserts the candidate learning resource into an (initially empty) ILP (and, therefore, the learning resource is no longer a candidate). For a candidate learning resource, learning path generator 134 may consider multiple skill pairs from the skill dependency graph, one skill pair for each skill associated with the candidate learning resource.

In a related embodiment, instead of (1) the model outputting a learning resource and then (2) using the skill dependency graph to check whether the outputted learning resource (a) teaches one or more skills required by the user (whether a destination skill or a prerequisite skill) and (b) does not require any skills that the user does not already have or that the user will not have after consuming any prior model-determined learning resources for the user, then repeating steps (1) and (2) until the set of destination skills are achieved through the determined learning resources, step (2) may be achieved through an implicit model as part of the resource generation step (i.e., step (1)). Thus, an explicit step (2) check might not be needed.

While the model internally outputs learning resources sequentially, a single “run” of the model maps the input to a complete sequence of resources. If or when the model outputs a job title or job function, then the model stops.

In an embodiment where the skill dependency graph includes skill pairs that are associated with (or indicate) non-binary values representing whether one skill is a prerequisite of another (such as a probability), applying one or more skill pairs as a constraint to a candidate learning resource may involve determining whether a non-binary value associated with a skill pair is over a threshold number (e.g., 0.6). If so, then the skill pair is applied as a constraint to determine whether the candidate learning resource is to be added to the ILP. Otherwise, the skill pair is not applied as a constraint (i.e., the skill pair is ignored). Alternatively, low probability skill pairs are filtered out and, therefore, would not be considered at this stage.

In a related embodiment, a career goal is also input to the model and the model uses that career goal to know when to stop generating an ILP. In an alternative embodiment, a career goal is not input to the model. Instead, the model identifies one or more learning resources for an ILP until the model identifies an end point or career goal, which may in the form of a job title or a set of skills.

### Embeddings

The user attributes that are input to a sequencing model may be machine-learned embeddings. An embedding is a vector of real numbers. “Embedding” is a name for a set of feature learning techniques where words or identifiers are mapped to vectors of real numbers. Conceptually, embedding involves a mathematical embedding from a space with one dimension per word/phrase (or identifier) to a continuous vector space.

One method to generate embeddings includes artificial neural networks. In the context of linguistics, word embedding, when used as the underlying input representation, have been shown to boost performance in natural language processing (NLP) tasks, such as syntactic parsing and sentiment analysis. Word embedding aims to quantify and categorize semantic similarities between linguistic items based on their distributional properties in large samples of language data. The underlying idea that a word is characterized by “the company it keeps.”

In an embodiment, in the context of learning resource selection, an embedding is learned for each of multiple learning resource attribute values and each of multiple user attribute values. Such attribute values may be string values or numeric identifiers. For example, a learning resource attribute includes a title, which, for a particular learning resource, may be a string of non-numeric characters or an identifier (e.g., “435256”) that uniquely identifies the learning resource.

The training data that is used to generate or “learn” embeddings for different attribute values comprises a portion of the user attribute data described previously. In order to generate the training data, the original user attribute data may have been augmented with additional information and/or may have been filtered to remove unnecessary data, such as timestamp data. For example, given a consumption data item (indicating consumption of a learning resource) that includes a user identifier, the user identifier is used to look up, in a profile database, a profile and retrieve one or more data items from the profile, such as one or more most recent job titles, one or more skills, and an industry. If the retrieved attribute values are names and not identifiers, then each retrieved attribute value name may be used to lookup, in a mapping (e.g., “‘Software Engineer’→87654”), a unique internal identifier that is mapped to the retrieved attribute value name. As another example, given a consumption data item that includes a learning resource identifier, the learning resource identifier is used to look up, in a learning resource database, a record that includes one or more names (or identifiers) for different attributes of the corresponding learning resource.

Thus, each training instance indicates multiple user-related attribute values. User-related attribute values include: a user identifier that uniquely identifies a user (e.g., a member of a social network), one or more employer identifiers, each of which uniquely identifies an employer that the user may have specified in his/her profile; one or more job title identifiers, each of which uniquely identifies a job title that the user may have specified in his/her profile; one or more skill identifiers, each of which uniquely identifies a skill that the user may have specified in his/her profile; and an industry identifier that uniquely identifies an industry that the user may have specified in his/her profile or that may have been derived based on a job title (and/or other information) associated with the user.

Each training instance also indicates whether the indicated learning resource was selected or otherwise interacted with by the indicated user. For example, a ‘1’ may indicate that the corresponding user consumed (e.g., watched) the corresponding learning resource and a ‘0’ may indicate that the corresponding user did not consume the corresponding learning resource. Additionally, a non-binary label may be used (e.g., a value between 0 and 1) indicating that a certain subset of the corresponding learning resource was consumed. For example, if a user viewed 75% of a video, then a label for this consumption may be 0.75 instead of 1.0.

The consumption data items upon which the training data is based may be limited to consumption data items that were generated during a certain time period, such as the last fourteen days.

In training multiple artificial neural networks, embeddings for attribute values that are indicated in the training data may be initialized to random numbers at the beginning. During the training process, each embedding is continuously modified until the embedding “stabilizes”, such that the attribute value that is being optimized stops significantly improving. Training may be performed in small batches and embeddings may be updated after each batch. A stabilized embedding becomes a “final” embedding for the corresponding attribute value. A final embedding and its corresponding attribute value may be stored in a mapping or table of multiple final embeddings. For example, one table may store associations between final embeddings and attribute values pertaining to users and another table may store associations between final embeddings and attribute values pertaining to learning resources.

The training process involves gradient descent and backpropagation. Gradient descent is an iterative optimization algorithm for finding the minimum of a function, such as a loss function. Backpropagation is a method used in artificial neural networks to calculate the error contribution of each neuron after a batch of data is processed. In the context of learning, backpropagation is used by a gradient descent optimization algorithm to adjust the weight of neurons (or nodes) in a neural network by calculating the gradient of the loss function. Backpropagation is also referred to as the “backward propagation of errors” because the error is calculated at the output and distributed back through the network layers. For models involving embeddings, there is an implicit input layer that is often not mentioned. The embeddings are actually a layer by themselves and backpropagation goes all the way back to the embedding layer. The input layer maps inputs to the embedding layer. Backpropagation begins at the final (output) layer that generates the probabilities and is applied per batch. Batch size depends on several factors, including the available memory on the computing device or GPU.

After generating embeddings for different attribute values of different attributes during the training process, the embeddings are associated with their respective attribute values. For example, an embedding for a first learning resource is stored in association with the first learning resource (such as a unique learning resource identifier). Similarly, an embedding for a particular skill (e.g., “Cloud Computing”, which may be mapped for a particular internal identifier that represents that skill) is stored in association with that particular skill.

Later, when a ILP generation process is initiated (e.g., by a particular user or by server system 130), embeddings of attribute values of the particular user are retrieved, along with embeddings of attribute values of a learning resource that is candidate for including an in ILP for the particular user. For example, a content request may include a user/member identifier that is used to lookup a profile of the particular user in a profile database. As part of the lookup, certain attribute names are used in the lookup, such as “Job Title”, “Employer”, etc. The corresponding attribute values are retrieved from the profile. One or more mappings of attribute values to their respective embeddings are accessed to determine the embeddings of the retrieved attribute values. As noted previously, there may be a separate mapping or table for each attribute. For example, one mapping is used for employer while another mapping is used for job title. The retrieved embeddings are then combined (e.g., concatenated) to generate an initial user-level embedding, which is input to the artificial neural network.

On the learning resource side, for each candidate learning resource, attribute values of the candidate learning resource are identified and, for each attribute value, an embedding is retrieved. Then, an initial learning resource-level embedding is generated for a candidate learning resource based on (e.g., by concatenating) the individual embeddings retrieved for the candidate learning resource. The learning resource-level embedding is then input into the artificial neural network.

### Computer-Related Improvements

Embodiments described herein represent a computer-related improvement over prior learning assistance computer systems. Embodiments consider attributes and/or activity of individual users and their respective career goals in crafting individualized learning paths. Thus, even though two users might have the same goal, because they may be at very different points in their respective careers, different ILPs will be generated for the respective users. As a result of embodiments described herein, if a user follows her ILP, then she will reach her career goal through an orderly acquisition of skills needed for that career goal.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

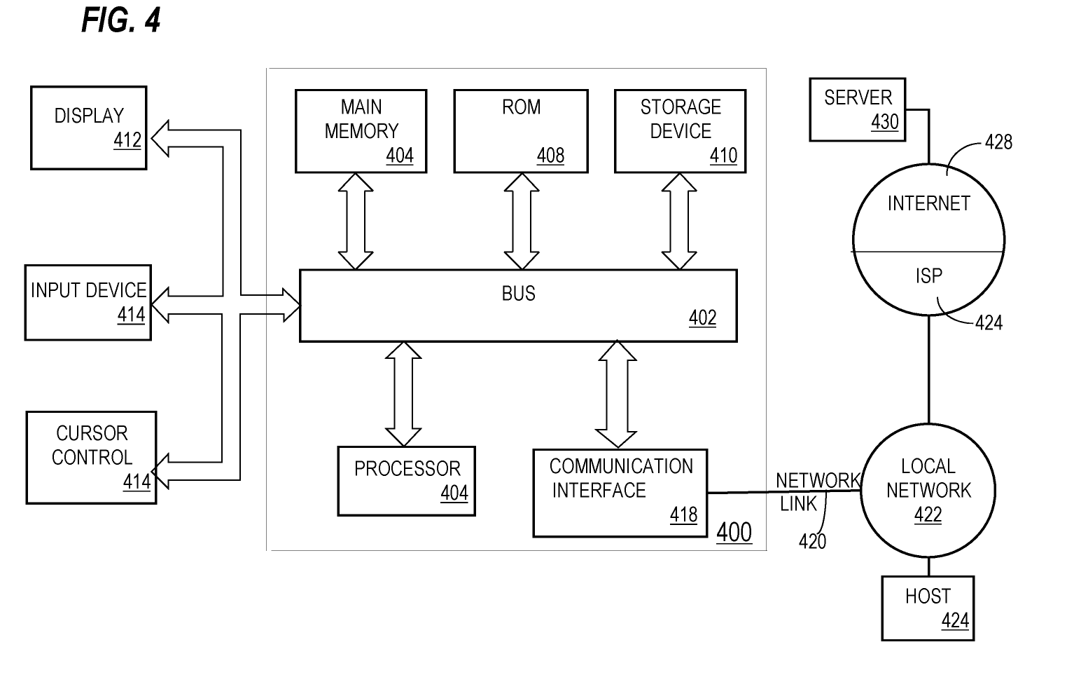

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
generating a skill dependency graph that indicates, for each pair of connecting nodes in the graph, a first skill in said each pair as a prerequisite of a second skill in said each pair;
determining a set of destination skills that a particular user is to obtain to achieve a possible career goal;
based on the skill dependency graph and the set of destination skills, identifying one or more prerequisite skills that the particular user should obtain prior to obtaining the set of destination skills;
generating, based on the set of destination skills, the one or more prerequisite skills, and information about the particular user, an individualized learning path that comprises a sequence of learning resources that allows the particular user to obtain a set of skills;
causing the individualized learning path to be displayed on a screen of a computing device of the particular user;
wherein the method is performed by one or more computing devices.

2. The method of claim 1, wherein:
generating the sequence of learning resources comprises generating a plurality of sequences of learning resources, each sequence in the plurality of sequences of learning resources corresponding to a different set of skills; and
the method further comprising:
causing the plurality of sequences of learning resources to be displayed on the screen of the computing device of the particular user.

3. The method of claim 1, wherein the possible career goal comprises a job listing provided by a particular organization, a job title, a job function, or a particular set of destination skills.

4. The method of claim 1, wherein determining comprises receiving, from the computing device of the particular user, input that specifies the possible career goal.

5. The method of claim 1, further comprising:
performing an analysis of second information about the particular user and determining the possible career goal based on the analysis.

6. The method of claim 1, further comprising:
performing an analysis of changes in skills in a plurality of user profiles over time;
wherein the skill dependency graph is generated based on the analysis.

7. The method of claim 1, wherein identifying the one or more prerequisite skills comprises:
for each skill in the set of destination skills:
using the skill dependency graph to identify a prerequisite skill of said each skill;
adding the prerequisite skill to a set of prerequisite skills if it is determined that the particular user is not associated with the prerequisite skill;
for each skill in the set of prerequisite skills:
using the skill dependency graph to identify a second prerequisite skill of said each skill;
adding the second prerequisite skill to the set of prerequisite skills if it is determined that the particular user is not associated with the second prerequisite skill.

8. The method of claim 7, further comprising:
storing skill association data that associates, for each learning resource in a plurality of learning resources that includes the learning resources in the sequence, a set of skills;
wherein the skill association data associates (1) a first learning resource in the plurality of learning resources with a first set of skills and (2) a second learning resource in the plurality of learning resources a second set of skills that is different than the first set of skills;
identifying the sequence of learning resources based on the skill association data, the set of prerequisite skills, and the set of destination skills.

9. The method of claim 1, further comprising:
identifying one or more learning resources in the sequence of learning resources based on one or more resource selection criteria that comprises one or more of:
the fewest number of learning resources,
the shortest set of learning resources,
learning resources that are associated with the fewest skills that are not needed to learn the set of skills,
the highest ranked or highest rated learning resources, or
the most consumed learning resources.

10. The method of claim 1, further comprising:
training a machine learned model based on data about a plurality of users who have consumed learning resources and advanced in their respective careers;
wherein generating the individualized learning path comprises:
identifying, by the machine learned model, based on the information about the particular user, a first learning resource;
including the first learning resource in the sequence of learning resources;
identifying, by the machine learned model, based on the information about the particular user, a second learning resource that is different than the first learning resource;
including the second learning resource in the sequence of learning resources.

11. The method of claim 10, further comprising:
prior to including the first learning resource in the sequence of learning resources:
determining whether the first learning resource requires a skill that the user has;
including the first learning resource in the sequence of learning resources in response to determining that the first learning resource requires a skill that the user has;
prior to including the second learning resource in the sequence of learning resources:
determining whether the second learning resource requires a skill that the user already has or that is associated with the first learning resource;
including the second learning resource in the sequence of learning resources in response to determining that the second learning resource requires a skill that is associated with the first learning resource.

12. The method of claim 1, wherein the information about the particular user includes two or more of: current job title, past job title, current employer, past employer, consumed learning resources, submitted search queries, browsed learning pages, recently made connections made, and content of sent/received messages to/from certain users.

13. One or more storage media storing instructions which, when executed by the one or more processors, cause:
generating a skill dependency graph that indicates, for each pair of connecting nodes in the graph, a first skill in said each pair as a prerequisite of a second skill in said each pair;
determining a set of destination skills that a particular user is to obtain to achieve a possible career goal;
based on the skill dependency graph and the set of destination skills, identifying one or more prerequisite skills that the particular user should obtain prior to obtaining the set of destination skills;
generating, based on the set of destination skills, the one or more prerequisite skills, and information about the particular user, an individualized learning path that comprises a sequence of learning resources that allows the particular user to obtain a set of skills;
causing the individualized learning path to be displayed on a screen of a computing device of the particular user.

14. The one or more storage media of claim 13, wherein:
generating the sequence of learning resources comprises generating a plurality of sequences of learning resources, each sequence in the plurality of sequences of learning resources corresponding to a different set of skills; and
the instructions, when executed by the one or more processors, further cause:
causing the plurality of sequences of learning resources to be displayed on the screen of the computing device of the particular user.

15. The one or more storage media of claim 13, wherein the possible career goal comprises a job listing provided by a particular organization, a job title, a job function, or a particular set of destination skills.

16. The one or more storage media of claim 13, wherein determining comprises receiving, from the computing device of the particular user, input that specifies the possible career goal.

17. The one or more storage media of claim 13, wherein the instructions, when executed by the one or more processors, further cause:
performing an analysis of second information about the particular user and determining the possible career goal based on the analysis.

18. The one or more storage media of claim 13, wherein the instructions, when executed by the one or more processors, further cause:
performing an analysis of changes in skills in a plurality of user profiles over time;
wherein the skill dependency graph is generated based on the analysis.

19. The one or more storage media of claim 13, wherein the instructions, when executed by the one or more processors, further cause:
identifying one or more learning resources in the sequence of learning resources based on one or more resource selection criteria that comprises one or more of:
the fewest number of learning resources,
the shortest set of learning resources,
learning resources that are associated with the fewest skills that are not needed to learn the set of skills,
the highest ranked or highest rated learning resources, or
the most consumed learning resources.

20. The one or more storage media of claim 13, wherein the instructions, when executed by the one or more processors, further cause:
training a machine learned model based on data about a plurality of users who have consumed learning resources and advanced in their respective careers;
wherein generating the individualized learning path comprises:
identifying, by the machine learned model, based on the information about the particular user, a first learning resource;
including the first learning resource in the sequence of learning resources;
identifying, by the machine learned model, based on the information about the particular user, a second learning resource that is different than the first learning resource;
including the second learning resource in the sequence of learning resources.
